(19) United States
(12) Patent Application Publication
(10) Pub. No.: US 2017/0213191 A1
(43) Pub. Date: Jul. 27, 2017

(54) System, Method, and Apparatus for Mobile Workforce

(71) Applicant: AVERLENT CORPORATION, TARPON SPRINGS, FL (US)

(72) Inventor: Bruce Pitcher, TARPON SPRINGS, FL (US)

(73) Assignee: AVERLENT CORPORATION, TARPON SPRINGS, FL (US)

(21) Appl. No.: 15/003,125

(22) Filed: Jan. 21, 2016

(51) Int. Cl. G06Q 10/10; G06F 19/00; G06Q 50/22

(52) U.S. Cl. CPC G06Q 10/1095; G06Q 50/22; G06F 19/3418

(57) ABSTRACT

A system for managing a mobile workforce includes tools for directing and tracking the progress of mobile caregivers while providing tools and information to managers of the mobile caregivers as well as information on arrival, departure, and location to advocates of patients. When the caregiver arrives at the patient's home, a message is sent informing an advocate indicating arrival and, during the time the caregiver is with the patient, the advocate is able to determine the location of the caregiver's device (e.g., on a map application) and, in some embodiments, access video and/or audio of interactions with the patient. The location is particularly useful when the patent care includes transportation of the patient. Mechanisms are provided to determine possible substitute caregivers should something happen to a caregiver that is assigned to an appointment with a patient (e.g., flat tire).

### FIELD

This invention relates to medical services and more particularly to a system for managing services such as home healthcare and assisted transportation services.

### BACKGROUND

As the national population ages, more and more people are seeking in-home services and/or assisted transportation to/from appointments, shopping, etc. Many in this population have what is known as advocates such as a family member (child, sibling, etc.) who is concerned about the care being delivered. It is not always possible for these advocates to be at the patient's (loved one) location during the time when the caregiver is present. Therefore, the advocate may not know if the caregiver arrived, if the caregiver provided the requisite services, or how long the caregiver was present. This is often frustrating for advocates as in some patients/loved-ones, there is a medical reason why the patient does not remember or know if and when the caregiver visited the patient. Many such patients have Alzheimer's, dementia, or other afflictions that makes it a waste of time to even ask the patient if the caregiver was there, let alone when and for how long.

Equally frustrating is managing a mobile workforce, especially when those being served don't know or understand the expectations on the caregivers. There is little or no feedback from the patients as to whether care was provided, whether the caregiver arrived at the specified time, and whether the caregiver remained for the expected amount of time. Feedback from certain patients is provided in some circumstances when poor care, missed appointments, or tardiness occurs. Without such feedback, it is difficult for managers to know how well the caregivers are performing and to know if the caregivers are providing services at the agreed time and duration.

Using current tools, generally, caregivers fill out paper time sheets indicating when they arrived and departed each patient's home. Too often there are some caregivers who take liberties, are lax in completing the paperwork, and/or simply forget to complete paperwork in a timely manner and have to estimate later.

What is needed is a system that will manage such a mobile workforce and provide details of interactions to both the patient's advocate and the caregiver's management.

### SUMMARY

A system for managing a mobile workforce provides tools for directing and tracking the progress of mobile caregivers, while providing tools and information to managers of the mobile caregivers as well as information on status to advocates of patients of the caregivers.

Utilizing Global Positioning Service (GPS) technology in portable devices, the location of the caregiver in relationship to the patients is tracked and logged to provide accurate time accounting and billing. In addition, the same data is used to notify an advocate of the arrival and departure of a caregiver at the home of the advocate's loved one (patient). This provides enhanced comfort to the advocate, knowing that their loved one is being visited when expected. In some embodiments, the location of the caregiver is reported to the advocate between the arrival and the departure.

In one embodiment, a system for mobile workforce management includes a device for accessing the system by a caregiver. The device has a global positioning subsystem. Also included in the system is a server that has a set of appointments for the caregiver. Each appointment includes a location, a patient name, and a link for contacting an advocate. An application running on the portable device retrieves the set of appointments from the server and presents one of the appointments on a display of the device along with a directive indicating arrival at the one of the appointments. Upon execution of the directive indicating arrival, the application running on the device for accessing sends a transaction to the server indicating arrival at the location. Responsive to the transaction, the server informs the advocate through the link for contacting the advocate that care is being provided for the patient of the one of the appointments (e.g., the server sends a text message to the advocate of this patient).

In another embodiment, a method of managing a mobile workforce includes sending at least one appointment from a server to an application running on a portable device. Each of the at least one appointments includes a location, a patient name, and a link for contacting an advocate. The application running on the portable device presents one of the at least one appointment on a display of the portable device along with an icon indicating arrival. Upon selection of the icon indicating arrival, a message is sent to the link for contacting the advocate, the message for informing the advocate that care is being provided for the patient of the one of the appointments.

In another embodiment, program instructions tangibly embodied in a non-transitory storage medium comprising at least one instruction configured to implement a method of managing a mobile workforce. The at least one instruction includes computer-readable instructions for sending at least one appointment from a server to computer-readable instructions running on a portable device. Each of the at least one appointments includes a location, a patient name, and a link for contacting an advocate. There are computer-readable instructions running on the portable device that present one of the at least one appointments on a display of the portable device along with an icon indicating arrival. Upon selection of the icon indicating arrival, computer-readable instructions running on the portable device transact with a server and computer-readable instructions running on the server inform the advocate that care is being provided for the patient by way of the link for contacting the advocate (e.g., by sending a text message).

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the system for a mobile workforce.

FIG. 2 illustrates a schematic view of a typical cell phone.

FIG. 3 illustrates a schematic view of a typical computer system such as a server or personal computer.

FIG. 4 illustrates a first cell phone user interface of the system for a mobile workforce showing a text message with appointments.

FIG. 5 illustrates a second cell phone user interface of the system for a mobile workforce showing an application with appointments.

FIG. 6 illustrates a third cell phone user interface of the system for a mobile workforce showing details regarding an appointment.

FIG. 7 illustrates a fourth cell phone user interface of the system for a mobile workforce showing details of an appointment to which the caregiver is late.

FIG. 8 illustrates a fifth cell phone user interface of the system for a mobile workforce showing that the caregiver is at the appointment.

FIG. 9 illustrates a sixth cell phone user interface of the system for a mobile workforce showing that the caregiver has finished and checked out of the appointment.

FIG. 10 illustrates a cell phone user interface of the system for a mobile workforce showing the advocate the location of the caregiver with respect to the place of care.

FIG. 11 illustrates a cell phone user interface of the system for a mobile workforce showing a message to an advocate indicating that the caregiver has arrived at the place of care.

FIG. 12 illustrates a cell phone user interface of the system for a mobile workforce informing the advocate of the location of the caregiver.

FIG. 13 illustrates a cell phone user interface of the system for a mobile workforce showing a message to an advocate indicating that the caregiver has departed from the place of care.

FIG. 14 illustrates an employee data user interface of the system for a mobile workforce showing a list of caregivers.

FIG. 15 illustrates a patient data user interface of the system for a mobile workforce showing a list of patients.

FIG. 16 illustrates a schedule user interface of the system for a mobile workforce showing a visit schedule for one caregiver.

FIG. 17 illustrates a caregiver status user interface of the system for a mobile workforce showing historical data regarding a particular caregiver.

FIG. 18 illustrates a time report user interface of the system for a mobile workforce.

FIG. 19 illustrates a patient report user interface of the system for a mobile workforce showing dates, times, and durations of visits.

FIG. 20 illustrates an exemplary program flow of the system for a mobile workforce.

FIG. 21 illustrates a second exemplary program flow of the system for a mobile workforce.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

In general, the workforce management system provides capabilities to manage caregivers and provide information to managers and advocates when the caregiver is providing care to a patient. In the following description, an example of a home healthcare provider is used to describe the operation of the healthcare system, though the system is anticipated for use in other mobile workforce environments such as workforce environments for assisted transportation, etc.

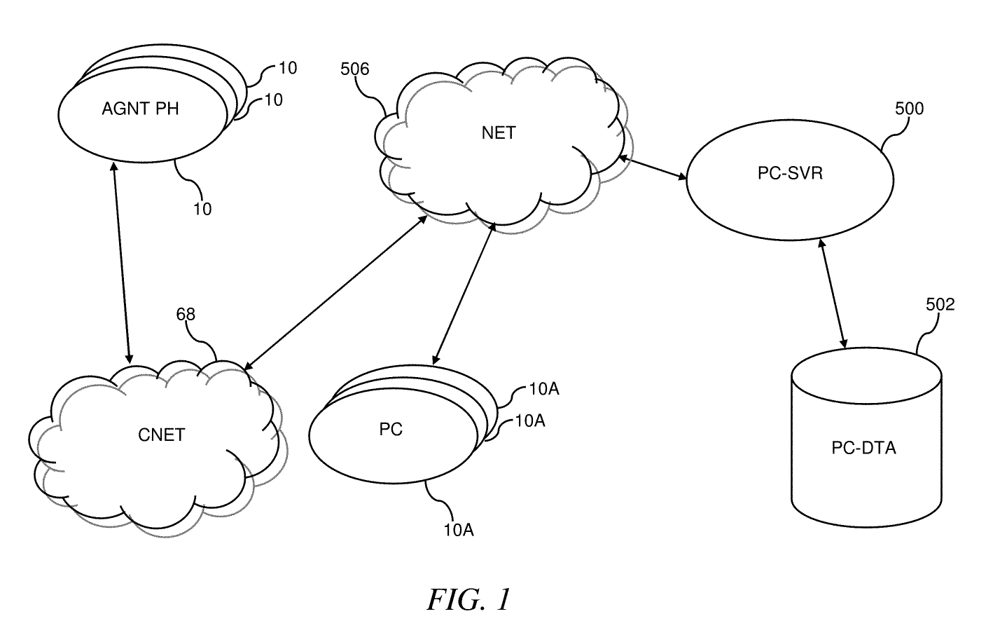

Referring to FIG. 1 illustrates a data connection diagram of the exemplary mobile workforce management system. In this example, one or more cell phones 10 communicate through the cellular network 68 and/or through a wide area network 506 (e.g. the Internet) to a server computer 500. In some embodiments, user computer systems 10A also communicate through the cellular network 68 and/or through a wide area network 506 (e.g. the Internet) to the server computer 500.

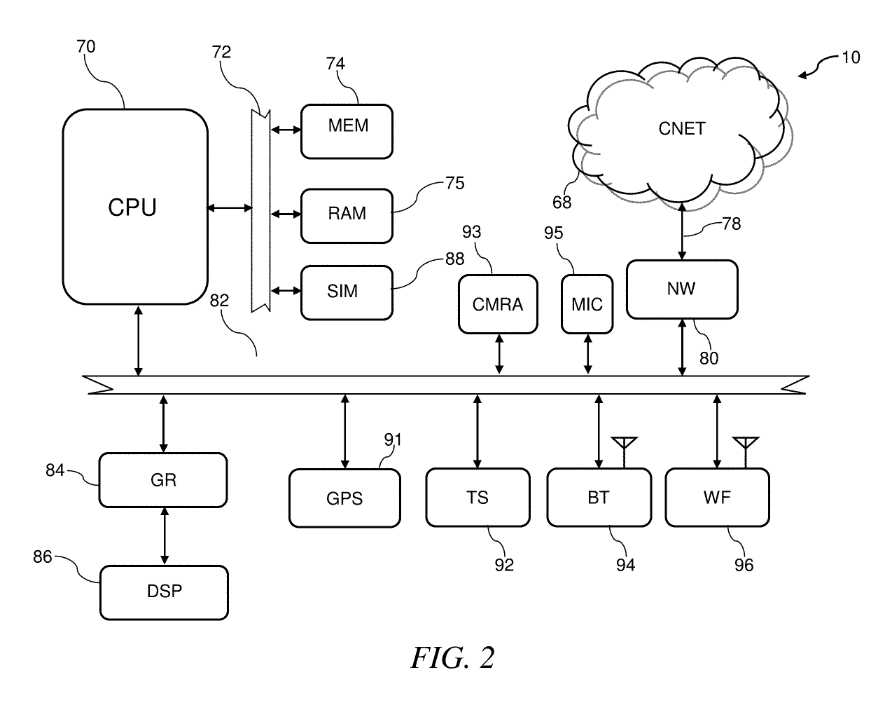

The server computer 500 has access to data storage 502. Although one path between the cell phones 10 and the server 500 is through the cellular network 68 and the wide area network 506 as shown, any known data path is anticipated. For example, the Wi-Fi transceiver 96 (see FIG. 2) of the cell phone 10 is used to communicate directly with the wide area network 506, which includes the Internet, and, consequently, with the server computer 500.

The server computer 500 transacts with the cell phones 10 through the network(s) 68/506 to present menus to/on the cell phones 10, provide data to the cell phones 10, and to communicate information such as caregiver location, etc. In some embodiments, login credentials (e.g., passwords, pins, secret codes) are stored local to the cell phone 10; while in other embodiments, login credentials are stored in a data storage 502 (preferably in a secured area) requiring a connection to login.

The server computer 500 transacts with applications running on the cell phones 10 and/or with applications (e.g., browsers) running on the user computers 10A.

In some embodiments, when the mobile workforce application begins running on the cell phone 10, the geographic area of the cell phone 10 is determined by reading the GPS subsystem 91 (see FIG. 2) of the cell phone 10 or by manual entry by a user. Manual entry by a user is made by, for example, entering a street address or by selecting a location on a map.

The location from the GPS subsystem 91 is forwarded to the server 500 periodically for caregiver tracking and/or the location is logged locally (e.g., at the cell phone 10) and forwarded to the server 500 at a later time.

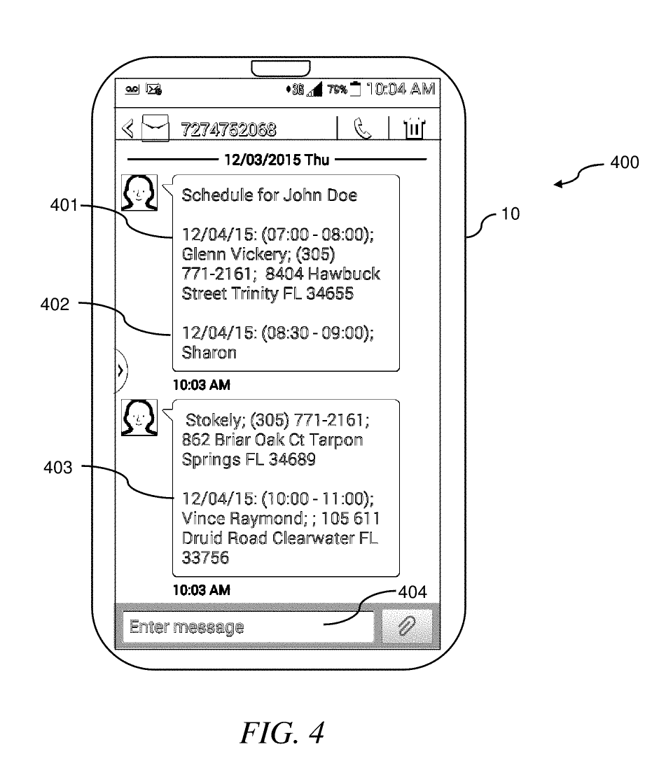

Referring to FIG. 2, a schematic view of a typical cell phone 10 is shown. The example cell phone 10 represents a typical phone system used for accessing user interfaces (see FIGS. 4-13) of the system for mobile workforce management. This exemplary cell phone 10 is shown in its simplest form. Different architectures are known that accomplish similar results in a similar fashion and the present invention is not limited in any way to any particular cell phone 10 system architecture or implementation. In this exemplary cell phone 10, a processor 70 executes or runs programs in a random access memory 75. The programs are generally stored within a persistent memory 74 and loaded into the random access memory 75 when needed. Also accessible by the processor 70 is a SIM (subscriber information module) card 88 having a subscriber identification and often persistent storage. The processor 70 is any processor, typically a processor designed for phones. The persistent memory 74, random access memory 75, and SIM card are connected to the processor by, for example, a memory bus 72. The random access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, magnetic memory, etc. In some exemplary cell phones 10, the persistent memory 74 is removable, in the form of a memory card of appropriate format such as SD (secure digital) cards, micro SD cards, compact flash, etc.

Also connected to the processor 70 is a system bus 82 for connecting to peripheral subsystems such as a cellular network interface 80, a graphics adapter 84 and a touch screen interface 92. The graphics adapter 84 receives commands from the processor 70 and controls what is depicted on a display image on the display 86. The touch screen interface 92 provides navigation and selection features.

In general, some portion of the persistent memory 74 and/or the SIM card 88 is used to store programs, executable code, phone numbers, contacts, and data, etc. In some embodiments, other data is stored in the persistent memory 74 such as audio files, video files, text messages, etc.

The peripherals are examples and other devices are known in the industry such as Global Positioning Subsystem 91, speakers, microphones, USB interfaces, Bluetooth transceiver 94, Wi-Fi transceiver 96, camera 93, microphone 95, image sensors, temperature sensors, etc., the details of which are not shown for brevity and clarity reasons.

The cellular network interface 80 connects the cell phone 10 to the cellular network 68 through any cellular band and cellular protocol such as GSM, TDMA, LTE, etc., through a wireless medium 78. There is no limitation on the type of cellular connection used. The cellular network interface 80 provides voice call, data, and messaging services to the cell phone 10 through the cellular network.

For local communications, many cell phones 10 include a Bluetooth transceiver 94, a Wi-Fi transceiver 96, or both. Such features of cell phones 10 provide data communications between the cell phones 10 and data access points and/or other computers such as a personal computer (not shown).

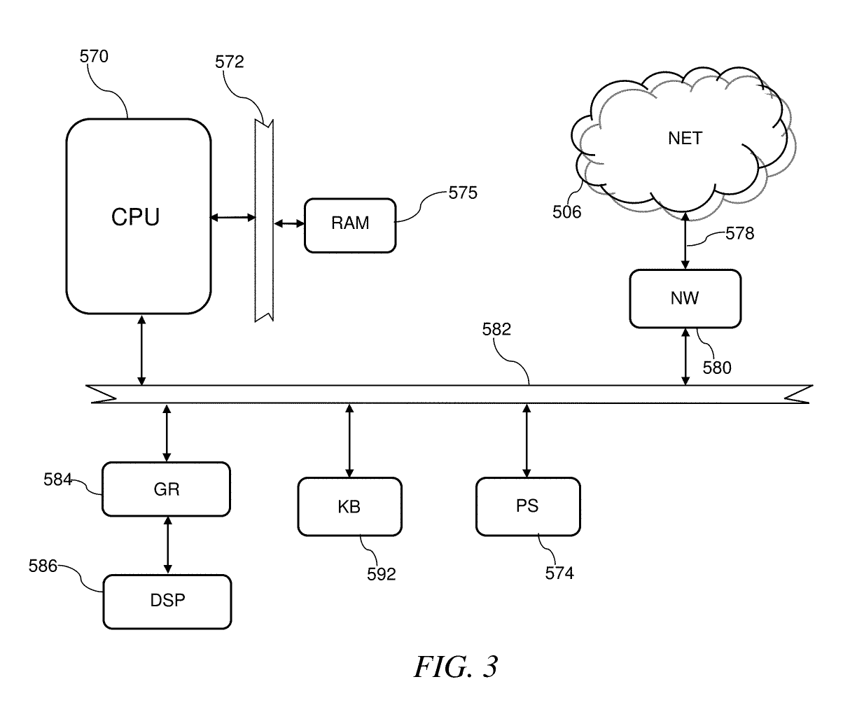

Referring to FIG. 3, a schematic view of a typical computer system (e.g., server 500 or user computer 10A) is shown. The example computer system 500 represents a typical computer system used for back-end processing, generating reports, displaying data, etc. This exemplary computer system is shown in its simplest form. Different architectures are known that accomplish similar results in a similar fashion and the present invention is not limited in any way to any particular computer system architecture or implementation. In this exemplary computer system, a processor 570 executes or runs programs in a random access memory 575. The programs are generally stored within a persistent memory 574 and loaded into the random access memory 575 when needed. The processor 570 is any processor, typically a processor designed for computer systems with any number of core processing elements, etc. The random access memory 575 is connected to the processor by, for example, a memory bus 572. The random access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus—USB). The graphics adapter 584 receives commands from the processor 570 and controls what is depicted on a display image on the display 586. The keyboard interface 592 provides navigation, data entry, and selection features.

In general, some portion of the persistent memory 574 is used to store programs, executable code, data, contacts, and other data, etc.

The peripherals are examples and other devices are known in the industry such as speakers, microphones, USB interfaces, Bluetooth transceivers, Wi-Fi transceivers, image sensors, temperature sensors, etc., the details of which are not shown for brevity and clarity reasons.

Referring to FIGS. 4-13, exemplary cell phone user interfaces of the system for mobile workforce management are shown. Although many user interfaces are anticipated, one example user interface is a text message interface 400 that is used to inform a caregiver of the upcoming caregiver's scheduled stops. The scheduling user interface 400 runs on a cellular phone 10 or other portable device. When the messaging application runs, for example, on the user's cell phone 10, the messaging application communicates with the server 500, receiving messages that include patients to be visited, along with times and locations. In this example, each appointment 401/402/403 includes a patient name, appointment time, and address, etc. In the example shown, the first appointment 401 is at a patient location for John Doe from 7 AM to 8 AM at 8404 Hawbuck Road in Trinity, Fla. The patient's phone number is also presented should the caregiver need to contact the patient. Two other patient appointments 402/403 are shown, although any number of appointments are anticipated, including one appointment. Other directives are anticipated, such as a “Back” directive 406 to navigate to a previous interface (not shown for clarity reasons).

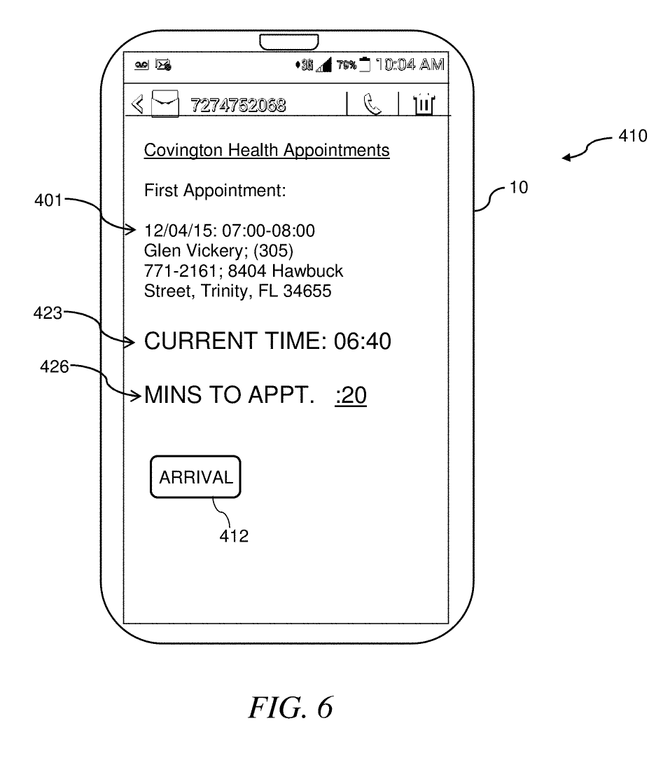

By selecting an appointment 401/402/403, an appointment user interface is presented as in FIG. 6. In many text-messaging applications, there is a field 404 for entering a response message, shown for completeness.

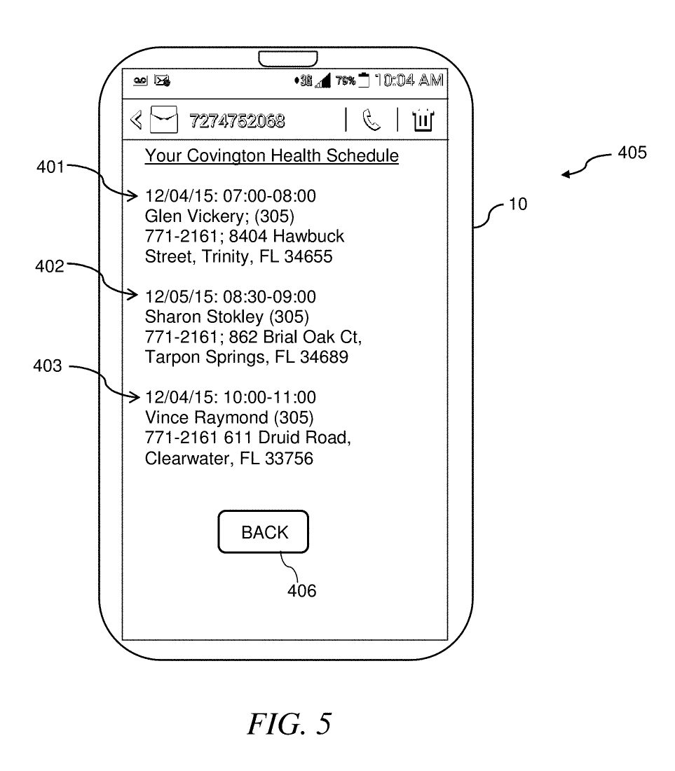

In an alternate embodiment, the appointment notices are interchanged between the server 500 and an application running on the cellular phone 10 and the appointment schedule 405 is displayed from the application as shown in FIG. 5. This example is similar to that of FIG. 4, showing the first appointment 401 is at a patient location for John Doe from 7 AM to 8 AM at 8404 Hawbuck Road in Trinity, Fla. The patient's phone number is also presented in case the caregiver needs to call the patient. Two other patient appointments 402/403 are shown, although any number of appointments are anticipated, including one appointment.

Again, by selecting an appointment 401/402/403 on the user interface 405, an appointment user interface 410 is displayed as shown as in FIG. 6.

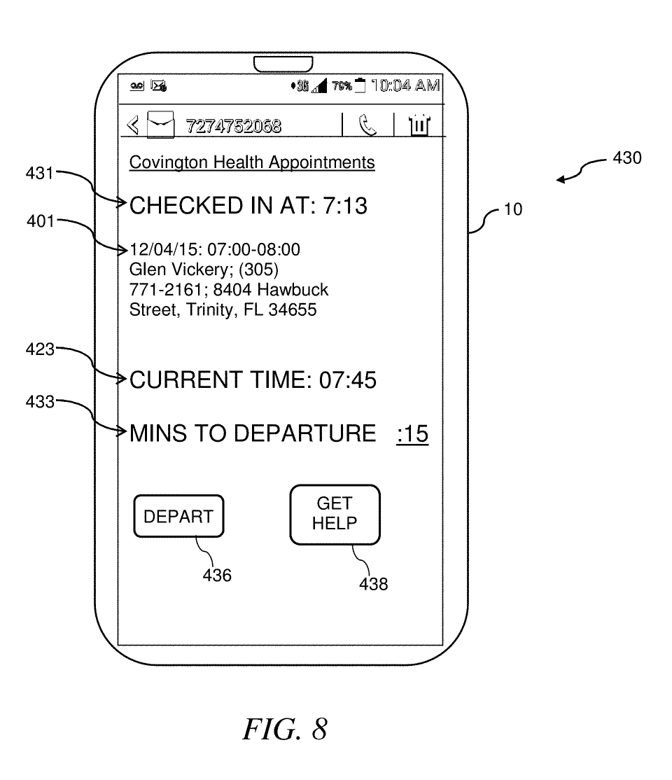

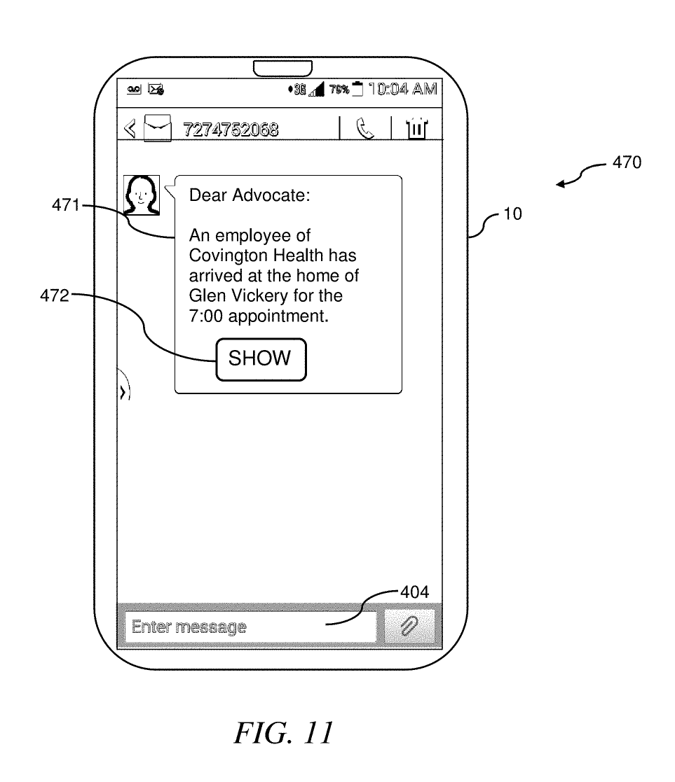

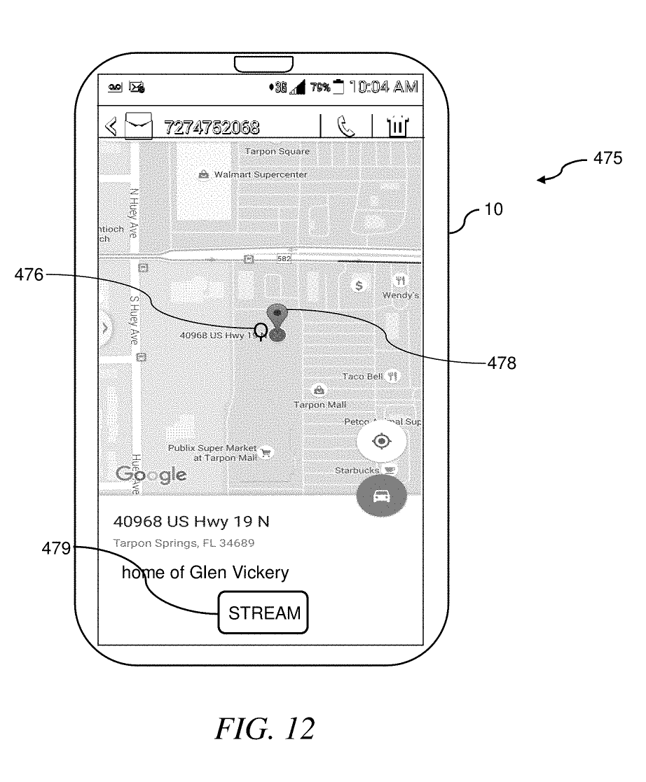

Referring to FIG. 6, a detail appointment user interface 410 of the system for a mobile workforce shows details regarding an appointment 401. In this, the caregiver has selected one of the appointments 401/402/403 from the appointment list user interface 405, for example the first appointment 401. In the detail appointment user interface 410, the first appointment 401 is shown along with the current time 423 and the amount of time until the appointment 401 begins 426 (note, this number is anticipated to be negative as represented as a negative number or a different color, indicating that the caregiver is late for the appointment 401). The detail appointment user interface 410 includes an “arrival” directive 412. When the caregiver arrives at the appointment 401, the caregiver invokes the “arrival” directive 412 to signal to the system that the caregiver is present at the appointment 401. Once the caregiver invokes the “arrival” directive 412, an advocate is notified (if an advocate is associated with the patient) as in FIGS. 11 and 12. Note that once the “arrival” directive 412 is selected, the advocate is able to view the location of the caregiver (e.g., as in FIG. 12) up until the caregiver invokes the “depart” directive 436 (see FIG. 8).

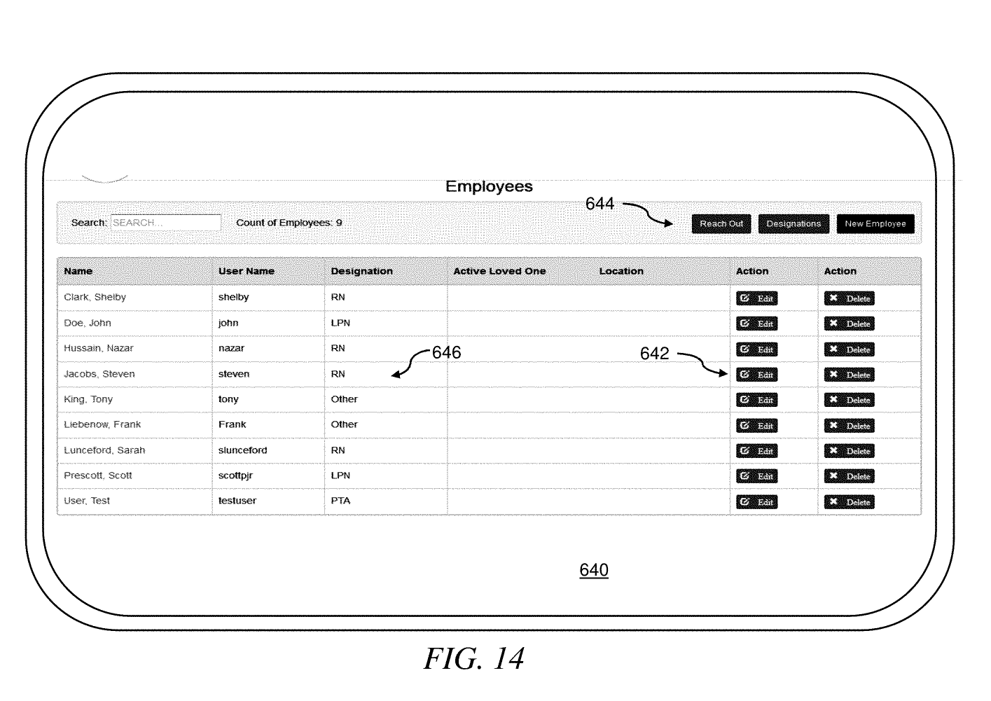

Should the caregiver not be able to make it to the appointment 401, the caregiver contacts a manager (e.g., by voice call or by text message) and, responsive to such, the manager invokes a “reach out” directive 644 to find another caregiver that can cover for this caregiver, as will be described with FIG. 14.

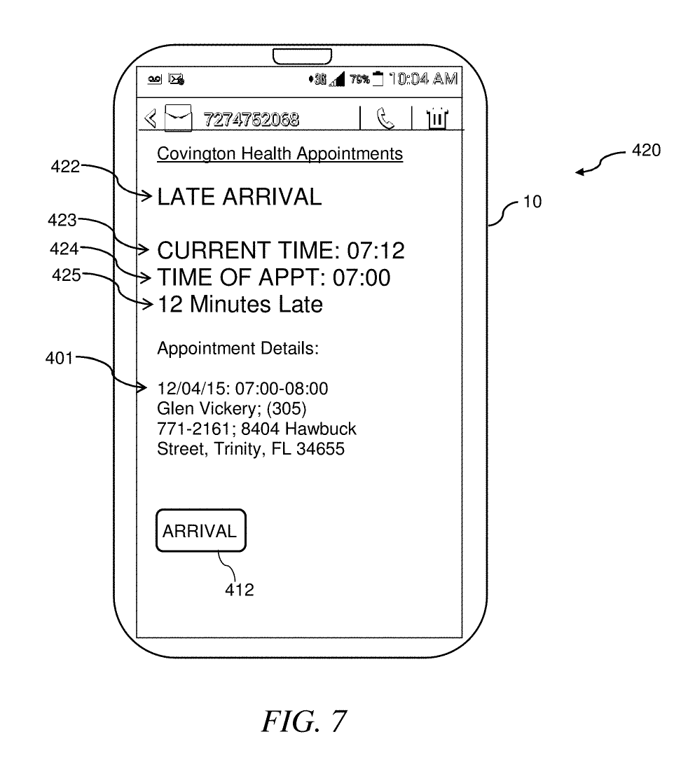

Referring to FIG. 7, a late arrival user interface 420 of the system for a mobile workforce shows details of an appointment to which the caregiver is late. The late arrival user interface 420 is similar to the detail appointment user interface 410, except it shows the fact that the caregiver is late 422 to the appointment 401 and indicates the current time 423, but also shows the start time of the appointment 424 and the number of minutes that the caregiver is late 425. The late arrival user interface 420 also includes the same directives as the detail appointment user interface 410; an “arrival” directive 412.

Should the caregiver not invoke the “arrival” directive 412 within a preset interval of the time of that caregiver's next appointment (e.g., the caregiver is late by the preset interval), the manager is sent a notice (e.g., from the server 500) indicating such, allowing the manager knowledge for use in contacting the caregiver to make sure they are alright, finding alternate caregivers (see “reach out” directive 644 in FIG. 14), and for feedback and improvement purposes. By such notification to the manager, the manager is able to prepare, should the advocate for this particular patient call and query as to why the caregiver has not arrived. This set interval, or tolerance threshold, defaults to a specific number of minutes (e.g., five minutes) and is changeable by the manager(s).

Should the caregiver invoke the “arrival” directive 412 before arriving at the patient's place of residence and the caregiver is further than a pre-set distance from the patient's place of residence, another message is sent to the manager indicating that the caregiver has signaled arrival early. For example, if the pre-set distance is one-half mile and the caregiver invokes the “arrival” directive 412 when the caregiver is one mile from the patient's place of residence, the manager is informed, enabling corrective action and feedback to the caregiver and providing data for the manager to edit billing records to discount for the time that was not actually spent with the patient. In some embodiments, the message includes an identification of the caregiver (e.g., name), the patient name, and/or the actual distance that the caregiver is from the residence of the patient. In any case, the advocate receives a message indicating that the caregiver has arrived at the residence of the patient as explained in FIG. 11.

In some embodiments, once the “arrival” directive 412 is invoked, a camera 93 and/or microphone 95 of the caregiver's cell phone 10 is activated to record audio and/or video transcripts of the interaction between the caregiver and the patient. In some embodiments, during the interval between when the caregiver invokes the “arrival” directive 412 and when the caregiver invokes the “departed” directive 436, a video and/or audio stream will be available to the advocate so that the advocate sees and/or hears the interactions between the caregiver and the patient. In some embodiments in which the video and/or audio stream is available, the advocate will have a function to initiate viewing and/or listening such as the “stream” directive 479 of FIG. 12 either only during the period between when the caregiver invokes the “arrival” directive 412 and when the caregiver invokes the “departed” directive 436 while in other embodiments, the advocate will have a function to initiate viewing and/or listening such as the “stream” directive 479 of FIG. 12, even after the caregiver invokes the “departed” directive 436, retrieving stored video and/or audio from the data storage 502. The manager will always have access to each video and/or audio stream for employee improvement programs and responses to client questions, etc.

Referring to FIG. 8, a user interface 430 showing the caregiver is at the appointment is shown. The user interface 430 showing the caregiver is at the appointment is a result of the caregiver invoking the “arrival” directive 412 (see above), showing the time that the caregiver checked in 431, the current time 423, and the number of minutes until the caregiver is expected to depart 433 from the appointment.

The user interface 430 showing the caregiver is at the appointment has a “depart” directive 436 and a “get help” directive 438. The “depart” directive 436 informs the system for a mobile workforce that the caregiver has departed from the current appointment 401. In some embodiments, a “get help” directive 438 is provided to provide fast access to a network of first responders. Invoking the “get help” directive 438 initiates processes that, for example, issue a call to 911 for emergency response, signals management so that management can direct other caregivers to the location of the appointment, etc. Once the caregiver invokes the “depart” directive 436, the location of the caregiver is no longer visible to the advocate (e.g., the location of the caregiver as in FIG. 12 is disabled or replaced with a message). The location of the caregiver is still discoverable by a manager as long as the caregiver remains active in the application.

Should the caregiver leave the residence of the patient without invoking the “depart” directive 436, notices are sent to the caregiver (and optionally to the manager). The notices inform the caregiver to the fact that they may have forgotten to invoke the “depart” directive 436 as a reminder and, generally have an “override” feature to inform the system that the caregiver is still providing care to the patient, for example, transporting the patient. In some embodiments, the missed departure notices are sent once the caregiver reaches a specific distance from the residence of the patient (e.g., one-half mile from the residence of the patient). The specific distance has a default value and there is a mechanism for a manager to change the warning distance. Once the caregiver reaches the specific distance from the residence of the patient, a first message is sent. As an example, if the caregiver is still at least the specific distance from the residence of the patient after a period of time, a second message is sent (e.g. 10 minutes after the first message) and after a greater period of time, a third message is sent (e.g. 30 minutes after the second message), and so on.

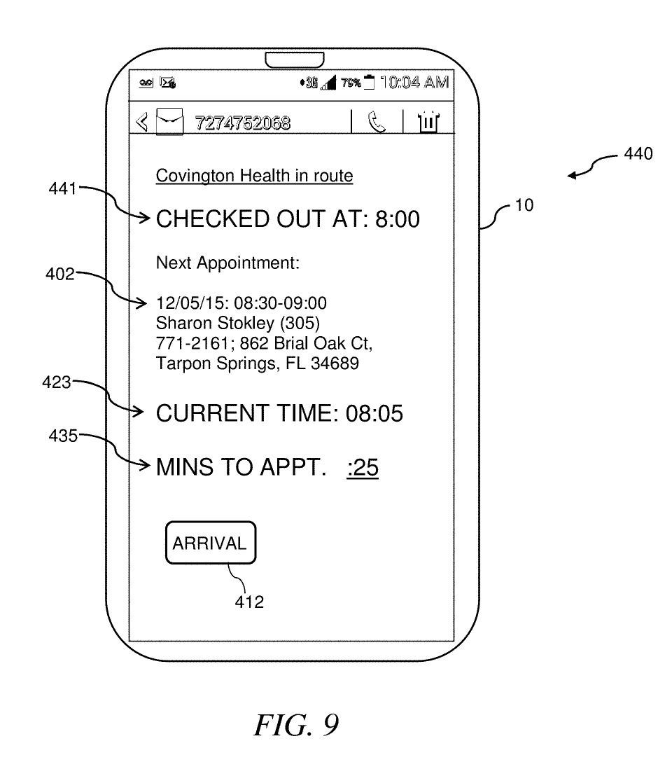

Referring to FIG. 9, an in-route user interface 440 of the system for a mobile workforce shows that the caregiver has finished and checked-out of the first appointment 401 and is in-route to the next appointment 402. For informational use, there is a display of the time that the caregiver checked out 441. In some embodiments, the distance traveled in-route is recorded and stored in the data storage 502.

In the in-route user interface 440, the next appointment from the appointments 401/402/403 is displayed, in this example the second appointment 402. In the in-route user interface 440, the appointment 402 is shown along with the current time 423 and the amount of time until the next appointment 402 begins 435 (note, this number is anticipated to be negative as represented as a negative number or a different color, indicating that the caregiver is late for the appointment 402). The in-route user interface 440 includes an “arrival” directive 412. When the caregiver arrives at the appointment 401, the caregiver invokes the “arrival” directive 412 to signal to the system that the caregiver is present at the appointment 402.

Should the caregiver not be able to make it to the appointment 402, the caregiver contacts a manager as described previously.

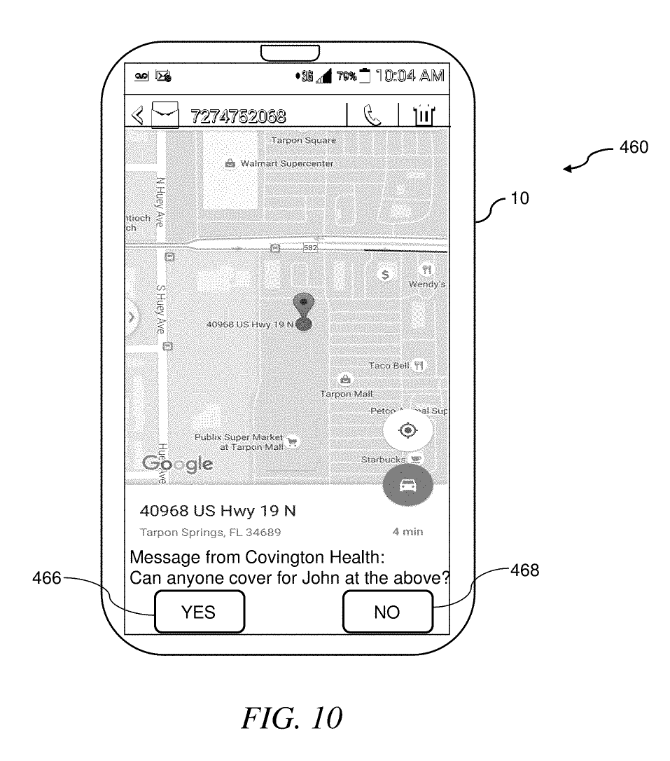

Referring to FIG. 10 illustrates request-for-coverage user interface 460 of the system for a mobile workforce shows the location from where the caregiver requests help. In this, the caregiver has contacted a manager (see FIG. 14) and the manager has invoked the “reach out” function 644 (see FIG. 14) requesting that some other caregiver cover for the next appointment 402. By using knowledge of the locations of each caregiver, the server 500 sends the request-for-coverage user interface 460 to all qualified caregivers in a specific radius or distance (e.g., measured in miles, or time). For example, if two qualified caregivers are within a five-minute drive of the next appointment 402 and all other qualified caregivers are further away, the request-for-coverage user interface 460 is sent to the two caregivers that are within a five-minute drive of the next appointment 402. If any of the caregivers that receive the request-for-coverage user interface 460 are able to cover, that caregiver responds by invoking the “yes” directive 466. Otherwise, that caregiver responds by invoking the “no” directive 468. A qualified caregiver is a caregiver that has the skills and/or certifications required to care for the patient of the next appointment 402.

In some embodiments, the server 500 determines an initial set of other caregivers based upon distance/travel-time from the next appointment 402 and sends the request-for-coverage user interface 460 to each in that set. If multiple other caregivers in the initial set respond by invoking the “yes” directive 466, the server 500 selects one and sends the selected caregiver an appointment user interface 410. The server 500 sends the other caregivers in the initial set a “thank-you, but no need” message.

In some embodiments, if all other caregivers respond by invoking the “no” directive 468, the server 500 determines another set of qualified caregivers by increasing the threshold of distance/travel-time from the next appointment 402 and sends the request-for-coverage user interface 460 to each in this new set, and so forth until the server 500 either finds another caregiver that can cover for the next appointment 402 or the server determines that the appointment cannot be covered and the server informs management and optionally the advocate that the appointment will have to be canceled or other action be taken.

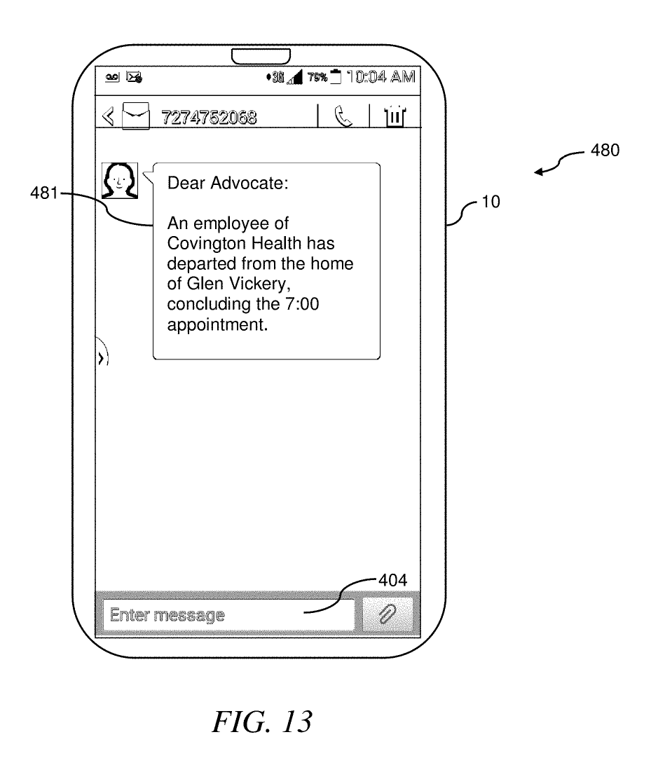

Referring to FIG. 11, an advocate user interface 470 of the system for a mobile workforce is shown. Although any user interface is anticipated, the advocate user interface 470 shown is a text message interface for informing an advocate (e.g., a parent, doctor, sibling, child who advocates for the patient) with a message 471 indicating that the caregiver has arrived at the place of care. The advocate user interface 470 provides peace of mind to the advocate that their loved one is receiving care at the anticipated time. Should the advocate want to see the location of the caregiver, the advocate selects the “show” icon 472 and a map as in FIG. 12 is displayed showing the location of the patient's residence 478 and the location of the caregiver 476, both being coincidental in the example shown. Note that, for some services, it is anticipated that the caregiver transports the patient, for example, for a doctor's visit, to a pharmacy, etc. In that case, it is anticipated that the location of the caregiver 476 will be distal from the patient's residence 478 until the caregiver (and patient) return to the patient's residence 478. Once the caregiver invokes the “depart” directive 436, the advocate no longer receives location information and the interface of FIG. 12 is replaced with an “inactive” message or a message as that shown in FIG. 13 is displayed.

In embodiments in which the caregiver captures video and/or audio of the interactions between the caregiver and the patient, the advocate has access to the video and/or audio through the “stream” directive 479. In such, invoking the “stream” directive 479 (e.g., after the caregiver invoked the “arrival” directive 412) results in a display of the video and/or reproduction of the audio at the device of the advocate. Once the caregiver invokes the “depart” directive 436, the advocate no longer has access to the video and/or audio stream. In some embodiments, the video and/or audio is saved in the data storage 502 for later access by the manager and/or the advocate.

Referring to FIG. 13, another advocate user interface 480 of the system for a mobile workforce is shown. Although any user interface is anticipated, this advocate user interface 480 is a text message interface for informing an advocate (e.g., a parent, doctor, sibling, child who advocates for the patient) with a message 481 indicating that the caregiver has departed from the place of care. The second advocate user interface 480 provides an indication of fulfilling the anticipated duration of the patient care as the message 481 is typically time/date stamped.

Referring to FIG. 14, an employee data user interface 640 of the system for a mobile workforce showing a list of caregivers is shown. For example, one caregiver 646 is Steven Jacobs. If this caregiver 646 is actively providing care (e.g., has notified of arrival and not yet departed), the patient and location being visited is shown. There are directives 642 for managers to edit or delete that caregiver. There are global directives for reaching out 644, designations, and adding a new caregiver.

The “reach out” directive 644 provides for on-the-fly staffing situations. For example, if a caregiver has a flat tire in route to an appointment, that caregiver involves the manager who invokes the “reach out” directive 644 to reach out to other caregivers (any caregiver that is logged in to the application) to try and substitute for the caregiver with the car trouble (as communicated by, for example, voice or text). To do this, the manager clicks on the “reach out” directive 644 and enters the address of the patient (e.g., selects one of the patients or a specific scheduled appointment). In some embodiments, the server 500 determines which other caregivers will receive the request-for-coverage user interface 460 (see description of FIG. 10 above), or alternately, the manager selects a desired radius/distance from which the other caregivers are from the subject location (e.g., from how far the manager wants to draw) and the designation of caregivers required to fill the patient's needs (e.g. the skills required such as that of a registered nurse, etc.). Once the distance and designations are entered, the manager issues the reach out. Those caregivers that meet the criteria (distance and skills) show up on the user interface for selection by the manager. The reach-out user interface 460 of the system for a mobile workforce is sent to each caregiver that meets the criteria, requesting a substitute caregiver at an appointment and requesting confirmation if they are able to substitute.

In some embodiments, once the caregivers who meet the criteria are identified, the manager then enters in a brief message. This message, along with details of the appointment, is sent to the caregiver who agreed to cover, e.g. by a text message or user interface similar to that of FIG. 6.

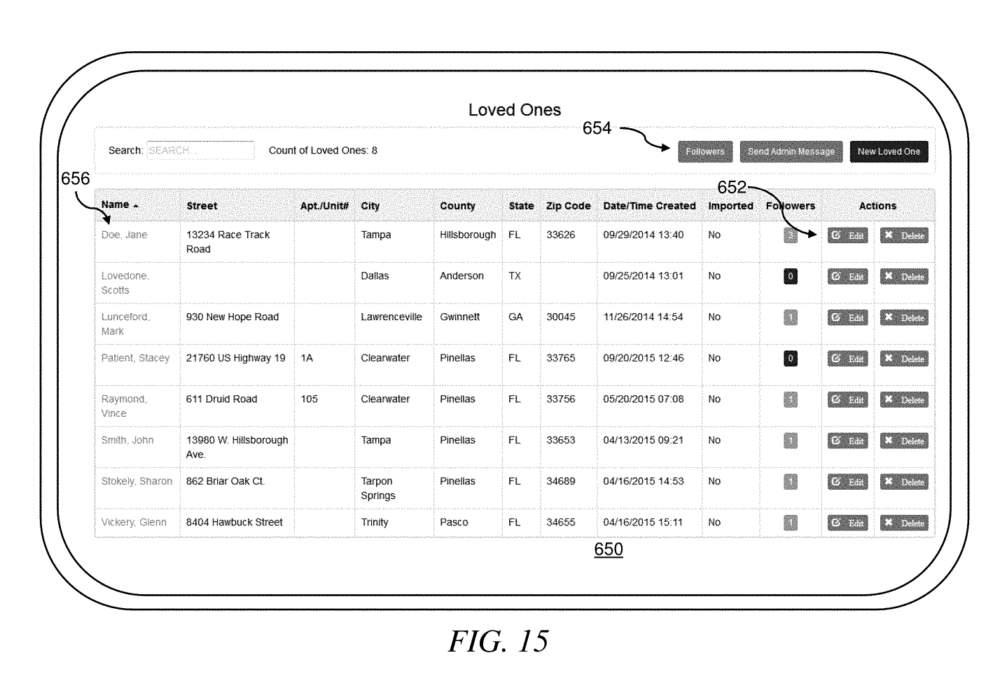

Referring to FIG. 15, a patient data user interface 650 of the system for a mobile workforce displaying a list of patients is shown. In this, data regarding each patient is listed, including the patient names 656, addresses, etc. Global directives 654 are provided to access followers for each of the patient (e.g. an advocate or a loved one of each patient), messaging, and adding of new patients and/or advocates. Each entry has directives 652 for editing or deleting the patient record.

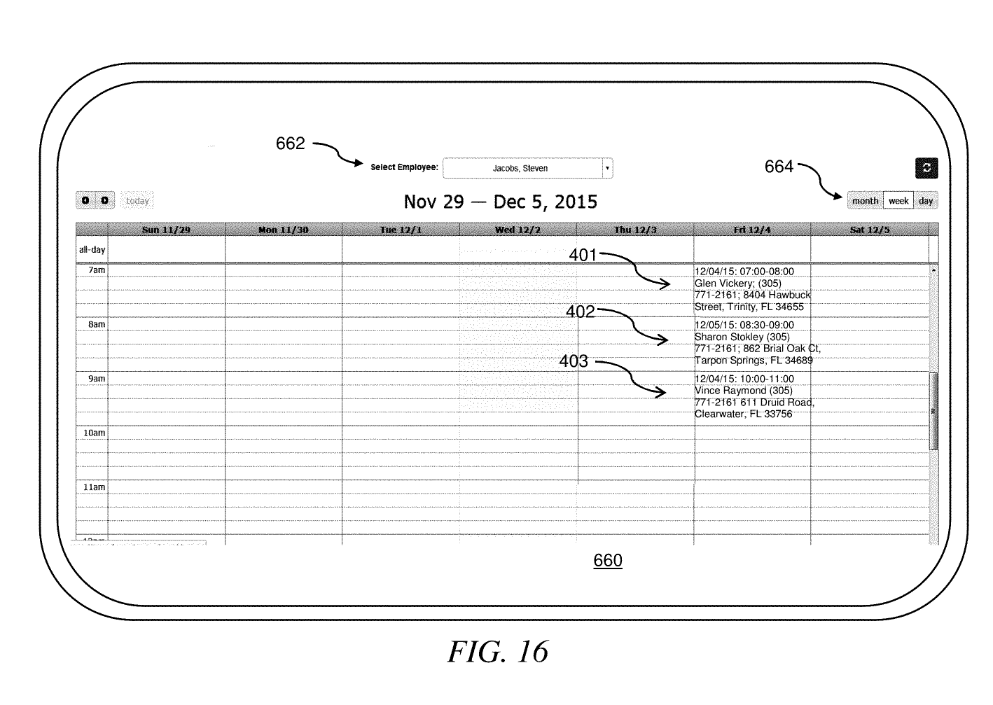

Referring to FIG. 16, a schedule user interface 660 of the system for providing care showing a visit schedule for one caregiver is shown. In this example, the schedule for one caregiver 662 (Steven Jacobs) is shown, having three patient visits 401/402/403 scheduled along with data regarding each visit. Global directives 664 are provided to change this view between a month-at-a-time, a week-at-a-time, and a day-at-a-time. The schedule is created both manually by a manager and/or automatically under program control. In automatic mode, a scheduler process running on the server 500 takes into account the needs of each patient that must be visited, the capabilities of each of the caregivers, and the distance/time between patients to suggest or propose a schedule for each caregiver as, for example, shown in FIG. 16. For example, the scheduler found three patients 401/402/403 that have need of services that match the skills of the selected employee (caregiver) 662 and that are close enough to each other as to provide ample time for the caregiver to drive from each appointment to the next. The scheduler allows for a manager to override the scheduler's suggestions, for example, changing the allotted drive time to a lower delta-time or a higher delta-time, etc., or to insert other patients in the schedule as needed. A manager also has the ability to assign different patients to specific caregivers, etc. The scheduler has heuristics that determine the schedule, taking into account the needs of each patient that must be visited, the capabilities of each of the caregivers, and the distance/time between patients, and the heuristics are tuned by, for example, parameters such as minimum delta-time, maximum patients per day, maximum drive time between patients, and blacklists (e.g., lists of caregiver-patient combinations to avoid, possibly due to previous conflicts or mistrust).

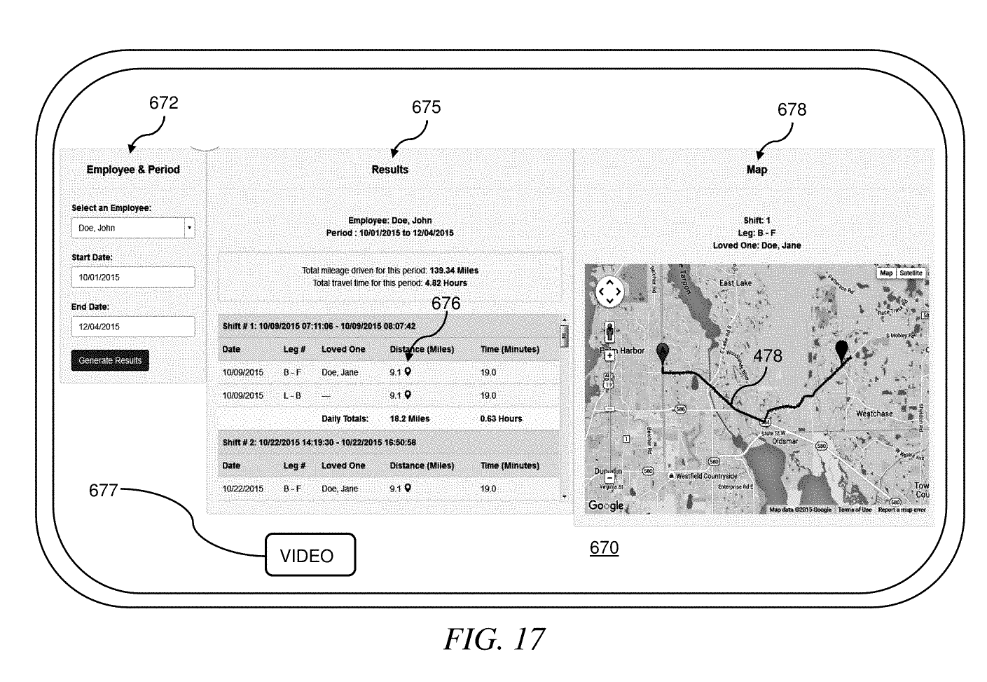

Referring to FIG. 17, a caregiver review user interface 670 of the system for a mobile workforce showing the prior activities of a particular caregiver is shown. In this example, one caregiver is selected (John Doe) along with a date range 672 and results for that caregiver are displayed. By selecting the flag icon 676 on one of the entries in the results 675, the route taken by the caregiver is displayed on a map 678.

Note that whenever a caregiver has activated the caregiver application on their cell phone 10, the manager has access to the location of the caregiver (e.g., as shown if FIG. 17). Once the caregiver is finished for the day, the caregiver exits the application and the manager no longer has access to the caregiver's location, for privacy of the caregiver. Historical data is maintained regarding the route taken by the caregiver for future reviews, as shown in FIG. 17.

In embodiments in which video and/or audio was captured by the caregiver during the appointment, the manager has access to the video and/or audio through a directive, e.g., as a “video” directive 677 in this example.

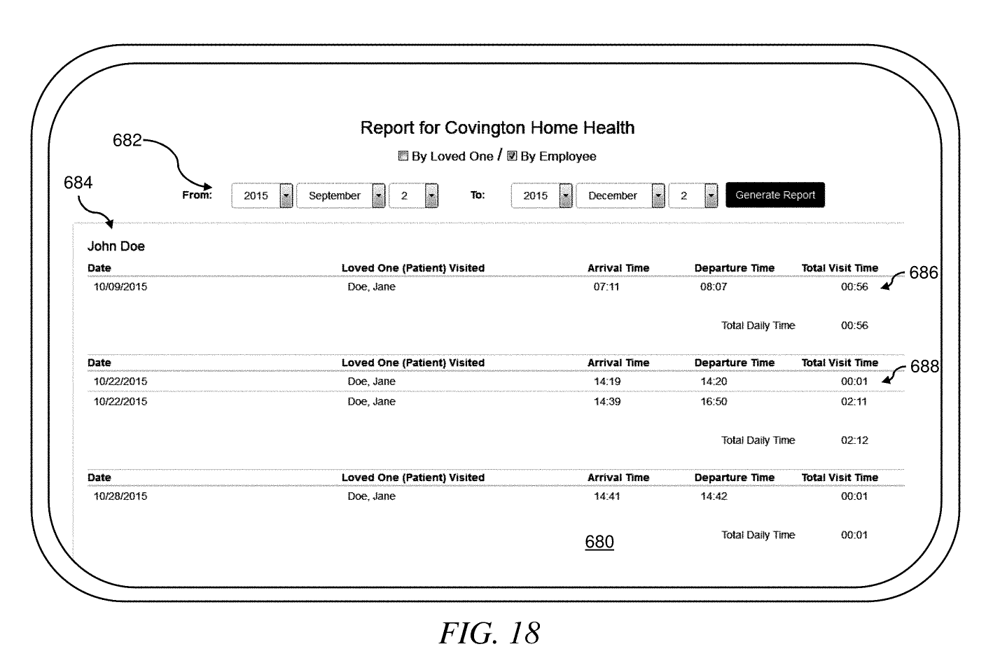

Referring to FIG. 18, a time report user interface 680 of the system for a mobile workforce is shown. The time report user interface 680 shows past visit records for one caregiver 684 (e.g., John Doe) for a specific date range 682. For example, this caregiver visited Jane Doe on 10/09/2015 arriving at 07:11 and departing at 08:07, for duration of 00:56 as shown in the first record 686. As another example, this caregiver visited Jane Doe on 10/22/2015 arriving at 14:19 and departing at 14:20, for a duration of 00:01 as shown in the second record 688.

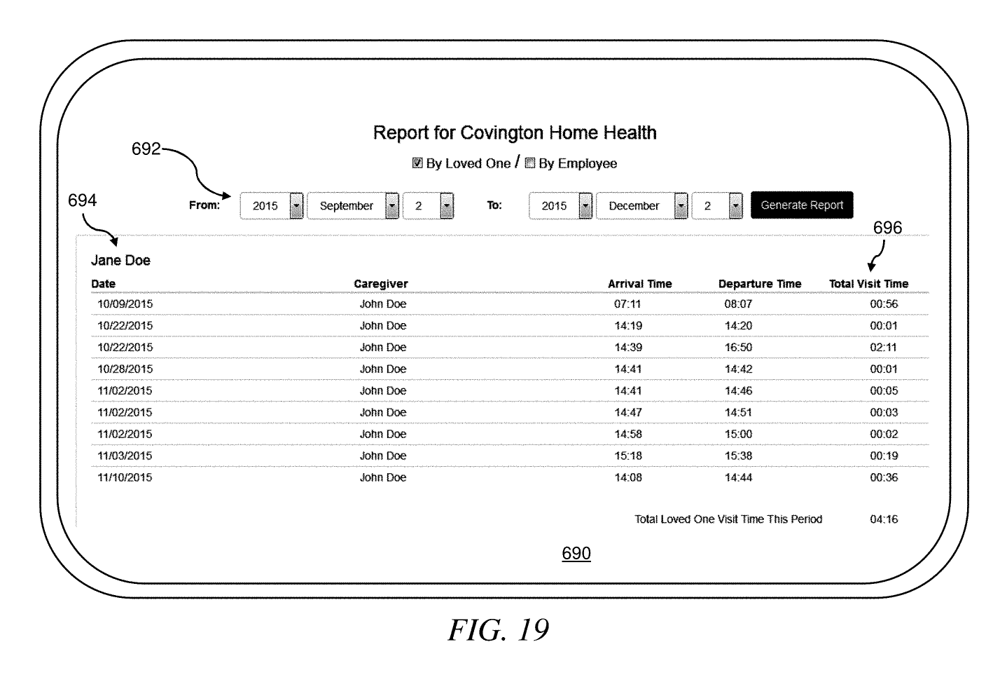

Referring to FIG. 19, a patient report user interface 690 of the system for a mobile workforce is shown having dates, times, and durations of visits. In this, a date range 692 is entered and a report generated showing prior visits to a particular patient 694 (Jane Doe in this example), along with visit arrival times, departure times, and durations 696.

All interactions between the caregivers and the patients are tracked and logged (e.g., the data in FIG. 19). For example, each completed appointment's start time, caregiver, end time, travel time, and mileage (e.g., mileage between appointments) is logged and stored in the patient care data 502. These records are later exported to other applications for time reporting and compensation of the caregivers and to other applications for billing of the patients or insurance companies.

In embodiments in which video and/or audio are captured, access to the video and/or audio is provided, for example, by selecting any one of the interactions of FIG. 19.

In some embodiments, data masking is provided to improve privacy. Data masking includes any redaction of information regarding the patient and/or advocate to improve privacy should an unauthorized person see any of the above data screens. For example, in notices to the advocate, the last name and address of the patient is redacted so anyone having access to the advocate's device will only know that a caregiver is visiting with a patient having a specific first name and, if the infiltrator does not know the advocate or patient, the infiltrator will not be able to determine the full name and address of the patient. Likewise, in some embodiments, date provided to the caregiver is also redacted so that the caregiver only knows the address and first name of the patient, etc. In some embodiments, the last name is redacted completely or it is truncated (e.g., “Jane Do” or “Jane D.” for “Jane Doe”).

The system has fallback operations using text messages for caregivers who do not have smart cell phones 10 that are capable of running the application. In such, the server receives and sends text messages to such advocate's non-smart cell phones 10. In this, the caregiver receives formatted messages and responds with specific words or phrases in text messages such as “arrived,” “departed,” etc. The server recognizes these words and takes similar actions as with the user interfaces above. It is anticipated that some cell phones 10 do not have location tracking systems and, in such cases, the only tracking available is when the caregiver sends a message saying where they are located (e.g., “arrived a Jane D's residence”).

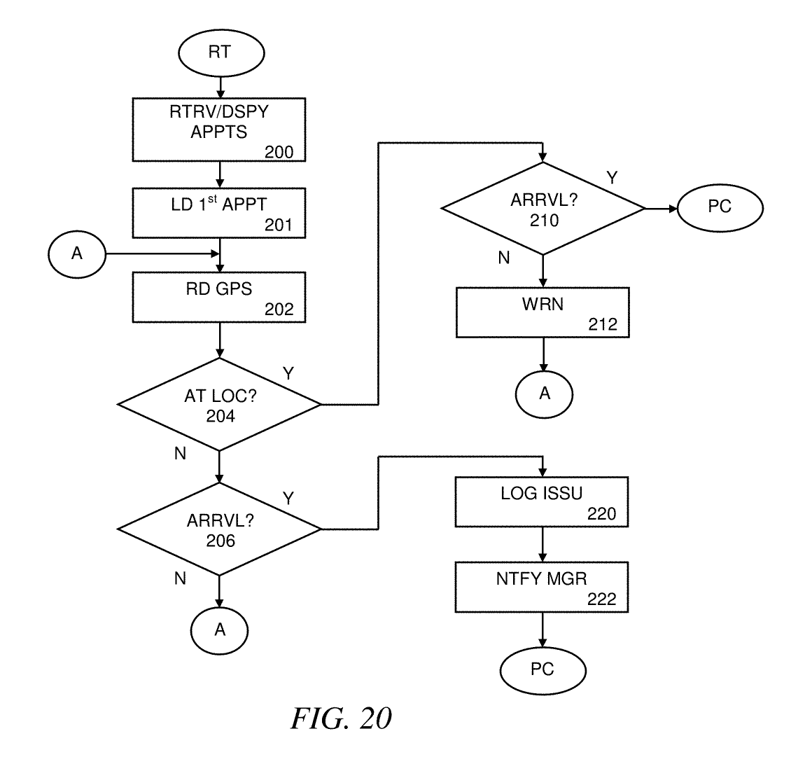

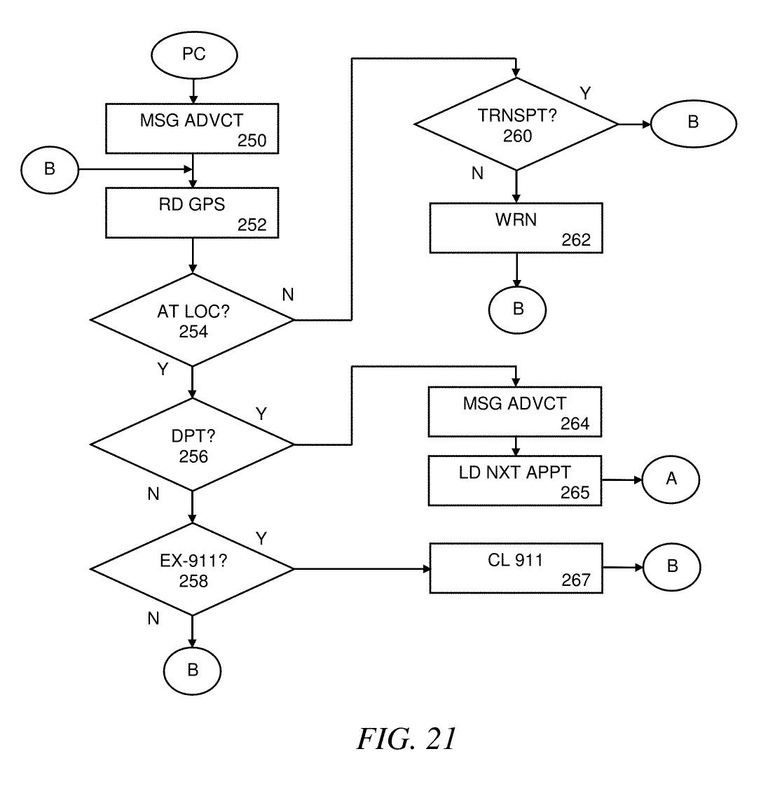

Referring to FIGS. 20 and 21, exemplary program flows of the system for a mobile workforce are shown.

It is anticipated that portions of the exemplary program flow execute on a user device such as a cell phone 10 and/or a personal computer 10A (e.g., using a browser or application running on the personal computer 10A) while portions of the exemplary program flow execute on the server 500.

In this example, the flow starts retrieving and displaying 200 the list of appointments. This is, for example, receiving a text message as in the text message interface 400 of FIG. 4 or by downloading the list of appointments into an application running on the cell phone 10 as in the appointment schedule 405 as shown in FIG. 5.

For brevity reasons, the selection of the first appointment is anticipated and the first appointment is loaded and displayed 201.

Each time through the loop A, the GPS subsystem 91 of the cell phone 10 is used to determine the location of the caregiver (assuming the cell phone 10 is in the locale of the caregiver). If the location of the cell phone is at the address of the appointment and the “arrival” 412 directive is invoked 210, patient care is underway (see FIG. 21). If the location of the cell phone is at the address of the appointment and the “arrival” 412 directive has not been invoked 210, the above is repeated at loop A, reading the location of the caregiver 202. In some embodiments, a delay is made between iterations as known in the industry.

If the location of the cell phone is not at the address of the appointment and the “arrival” 412 directive is invoked 210 (e.g., the caregiver is trying to indicate that he/she arrived but is not at the requisite location), steps are taken to provide feedback to the caregiver such as logging the issue 220 and notifying a manager 222 (e.g., sending a text message to the manager) before patient care begins (see FIG. 21).

Note that “at the address” is considered to be within a programmable distance of the address of the patient. For example, within 300 feet of the address of the patient or ½ mile of the patient, allowing for the caregiver to invoke the “arrival” 412 directive while remaining in a vehicle.

Once patient care commences, a message is sent 250 to the advocate, as for example, in the text message 470 of FIG. 12. During patient care a loop (B) begins with reading 252 the GPS subsystem 91 of the cell phone 10 to determine the location of the caregiver. If the caregiver in not at the location 254 and the type of care being provided is not transportation 260, a warning 262 is issued and the loop A continues. If the caregiver in not at the location 254 and the type of care being provided is transportation 260, the loop A continues.

If the caregiver is still at the location 254 and the caregiver has invoked the “depart” directive 436, in some embodiments, another message is sent 264 to the advocate indicating departure. The next appointment is loaded 265 and the loop A repeats (see FIG. 20) operating on the next appointment.

If the caregiver is still at the location 254 and the caregiver has not invoked the “depart” directive 436, but has invoked the “get help” directive 428 (see FIG. 8), any of various steps are taken such as using the cell phone 10 dialer subsystem to call for emergency services 267 (e.g., call 911), sending a text message to a manager to summon help, broadcasting an alert to nearby caregivers, etc. If the caregiver is still at the location 254, the caregiver has not invoked the “depart” directive, and the caregiver has not invoked the “get help” directive 428, the loop B repeats. Again, it is anticipated that there be a delay taken each time through the loop B.

In some embodiments, while the caregiver is with the patient (e.g., the caregiver has invoked the “arrival” directive 412 and has not invoked the “depart” directive 436), the advocate has the ability to see the location of the caregiver. This is anticipated for use in, for example, patient transportation. For example, once the caregiver has invoked the “arrival” directive 412 (e.g., is with a patient), the patient's advocate receives a message 471 indicating such. This patient's advocate has the ability to run an advocate user interface (not shown) similar to the user interface of FIG. 11, showing the location of the caregiver, and likewise, the location of the patient, assuming the patient is with the caregiver. Note that for privacy reasons, once the “depart” directive 436 is invoked, the patient's advocate is prevented from detecting the location of the caregiver and, likewise, no other advocates are allowed to view the location of the caregiver until the caregiver invokes the “arrival” directive 412 at the location of that advocate's loved one (patient). In this way, other advocates are not permitted to see/determine other patients that are being visited for privacy reasons.

In some embodiments in which the caregiver captures video and/or audio during the appointment, once the “arrival” directive 412 has been invoked and until the “departed” directive 436 is invoked, the advocate has access to view and/or listen to the video and/or audio. In some other embodiments in which the caregiver captures video and/or audio during the appointment, the advocate has access to view and/or listen to the video and/or audio even after the “departed” directive 436 is invoked, retrieving a stored copy from the data storage 502.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for mobile workforce management, the system comprising:
a portable device for accessing the system by a caregiver, the portable device having a global positioning subsystem;
a server, the server having a set of appointments for the caregiver, each appointment having a location, a patient name, and a link for contacting an advocate;
an application running on the portable device retrieves the set of appointments from the server and presents one of the appointments on a display of the portable device along with a directive indicating arrival at the one of the appointments;
upon execution of the directive indicating arrival, the application running on the portable device sends a transaction to the server for indicating arrival at the location;
responsive to the transaction, the server informs the advocate through the link for contacting the advocate that care is being provided for the patient of the one of the appointments.

2. The system of claim 1, whereas after the directive indicating arrival is invoked, the location is compared to a current location retrieved from the global positioning subsystem of the portable device and if the current location is further than a predetermined radius from the location, a notice is sent indicating an attempt to indicate arrival when not present, the notice for informing management of an issue with the caregiver.

3. The system of claim 1, whereas a directive indicative of departure is provided and, upon invocation of the directive indicative of departure, a departure transaction is sent to the server indicating that patient care at the one of the appointments is complete; responsive to the departure transaction, the server informs the advocate through the link for contacting the advocate that care is complete for the patient of the one of the appointments.

4. The system of claim 3, whereas between when the arrival transaction is received and when the departure transaction is received, the server provides location data to the advocate of the one of the appointments.

5. The system of claim 4, whereas the server provides the location data to the advocate of the one of the appointments on a map that is displayed on a second device.

6. The system of claim 1, wherein a reach-out directive is provided for use when the caregiver cannot make it the one of the appointments, responsive to activation of the reach-out directive, the server locates another caregiver to cover the next appointment of the caregiver.

7. The system of claim 6, whereas upon invocation of the reach-out directive, the server determines a set of other caregivers within range of the one of the appointments and the server transacts with each of the other caregivers within range of the one of the appointments requesting coverage and if any of the other caregivers within range of the one of the appointments agrees to coverage, the server transacts with one of the other caregivers that agrees to coverage, providing details of the one of the appointments.

8. The system of claim 3, wherein the application running on the portable device measures and records travel distance between appointments and the travel distance is sent to the server for recording and billing.

9. A method of managing a mobile workforce, the method comprising:
sending at least one appointment from a server to an application running on a portable device, each of the at least one appointments having a location, a patient name, and a link for contacting an advocate;
the application running on the portable device presents one of the at least one appointment on a display of the portable device along with an icon indicating arrival;
upon selection of the icon indicating arrival, a message is sent to the link for contacting the advocate, the message for informing the advocate that care is being provided for the patient of the one of the appointments.

10. The method of claim 9, further comprising comparing the location of the one of the appointments to a current location retrieved from a global positioning subsystem of the portable device and if the location of the one of the appointments is further than a predetermined radius of the current location, sending a notice of an attempt to indicate an early arrival, the notice of the attempt to indicate the early arrival for informing a manager that the caregiver has attempted to indicate the early arrival.

11. The method of claim 9, wherein an icon indicative of departure is provided and upon selecting the icon indicative of departure, the advocate that care is completed for the patient of the one of the appointments and a completion message is sent by the link for contacting the advocate for informing the advocate that care is complete for the patient of the one of the appointments.

12. The method of claim 11, whereas between selecting the icon indicative of arrival and selecting the icon indicative of departure, providing the current location to the advocate of the one of the appointments.

13. The method of claim 12, wherein the step of providing the current location includes sending the current location on a map that is displayed on a second device.

14. The method of claim 11, whereas between selecting the icon indicative of arrival and selecting the icon indicative of departure, providing a video and/or audio stream of care to the advocate, the video and/or audio stream of care captured by a camera and/or microphone of the portable device.

15. The method of claim 11, whereas at a time after selecting the icon indicative of departure, providing a video and/or audio stream of care to the advocate, the video and/or audio stream of care captured by a camera and/or microphone of the portable device and stored at the server.

16. Program instructions tangibly embodied in a non-transitory storage medium comprising at least one instruction configured to implement a method of managing a mobile workforce, wherein the at least one instruction comprises:
computer-readable instructions for sending at least one appointment from a server to computer-readable instructions running on a portable device, each of the at least one appointments having a location, a patient name, and a link for contacting an advocate;
computer-readable instruction running on the portable device presenting one of the at least one appointments on a display of the portable device along with an icon indicating arrival; and
upon selection of the icon indicating arrival, computer-readable instructions running on the portable device transact with a server and computer-readable instructions running on the server informing the advocate that care is being provided for the patient of the one of the appointments by way of the link for contacting the advocate from the one of the appointments.

17. The program instructions tangibly embodied in a non-transitory storage medium of claim 16, whereas the computer-readable instructions running on the portable device retrieve a current location from a location subsystem of the portable device and if the current location is not within a predetermined radius of the location of the one of the at least one appointment, sending a transaction to the server by the computer-readable instructions running on the portable device, and responsive to the transaction, sending a notice of an attempt to indicate early arrival when not present by the server, the notice for informing management of an issue with the caregiver.

18. The program instructions tangibly embodied in a non-transitory storage medium of claim 16 wherein an icon indicative of departure is provided and, upon selecting the icon indicative of departure, computer-readable instructions running on the portable device sending a departure transaction to the server indicating that patient care at the one of the appointments is complete; responsive to receiving the departure transaction, informing the advocate that care is completed for the patent of the one of the appointments by computer-readable instructions running on the server.

19. The program instructions tangibly embodied in a non-transitory storage medium of claim 18, whereas between selecting of the arrival icon and selecting of the departure icon, computer-readable instructions running on the server providing the current location to the advocate of the one of the appointments.

20. The program instructions tangibly embodied in a non-transitory storage medium of claim 19, wherein the computer-readable instructions running on the server providing the current location to the advocate of the one of the appointments include computer-readable instructions for presenting a map showing the current location on a second device.
